(19) United States
(12) Patent Application Publication
(10) Pub. No.: US 2026/0050846 A1
(43) Pub. Date: Feb. 19, 2026

(54) SYNCHRONIZATION SYSTEM AND METHOD FOR ASYNCHRONOUS INTERDEPENDENT COMPUTING ENVIRONMENTS

(71) Applicant: 2637257 ALBERTA INC., Airdrie (CA)

(72) Inventor: Leanne Sarah Elaine HUBER, Airdre (CA)

(21) Appl. No.: 19/071,118

(22) Filed: Mar. 5, 2025

Related U.S. Application Data
(60) Provisional application No. 63/682,681, filed on Aug. 13, 2024.

(51) Int. Cl. G06Q 10/0631; G06F 9/50

(52) U.S. Cl. CPC G06Q 10/06311; G06F 9/5083

(57) ABSTRACT

A system and method are provided for synchronizing interdependent asynchronous computing environments. A synchronization engine dynamically coordinates state updates across independent subsystems, ensuring consistency and reducing computational inefficiencies. A workflow management method assigns structured tasks to users, validating completion before triggering dependent state transitions. A synchronization method resolves conflicts, reallocates resources, and propagates updates to maintain system-wide consistency.

### CROSS-REFERENCE TO RELATED APPLICATION

This application claims priority from U.S. provisional patent application 63/682,681, filed Aug. 13, 2024, the entire contents of the foregoing are incorporated herein by reference.

### FIELD

The present specification relates generally to asynchronous computing environments and more particularly to a synchronization system and method for asynchronous interdependent computing environments.

### BACKGROUND

Many distributed computing environments rely on the interaction of independent subsystems that periodically synchronize state information but are otherwise asynchronous. In such environments, the accuracy and efficiency of state transitions depend on external actors executing prescribed actions within expected timeframes. However, when these actions are delayed, omitted, or completed out of order, system-wide inconsistencies emerge. These inconsistencies propagate through multiple interdependent computing engines, resulting in redundant data processing, conflicting event timestamps, and stale state transitions that require costly manual intervention. Common manifestations of this issue include scheduling systems that misallocate resources due to delayed user interactions, transaction validation engines that must repeatedly reconcile mismatched records across asynchronous systems, and multi-engine computing networks where state desynchronization increases computational overhead. As system complexity grows, failures in synchronizing state updates across independent engines exacerbate bottlenecks in processing efficiency, increase redundant query execution, and degrade overall system performance.

One example of a distributed computing environment facing such challenges includes hospital discharge and inpatient care. Coordination remains a critical challenge within modern healthcare systems, with delays, inconsistent communication, and insufficient preparation contributing to increased hospital bed occupancy and higher readmission rates. While digital health solutions have improved patient access to medical information, they often lack integration with hospital workflows, with asynchronicity remaining a core feature. For example, the myUHN Patient Portal deployed by the University Health Network (UHN) in Toronto allows patients to access test results and appointment schedules via their smartphones but does not provide dynamic discharge coordination. Similarly, UHN's Medly telemonitoring program enables heart failure patients to track symptoms and receive automated self-care recommendations, though its scope is limited to a specific condition.

Overall, there are many illustrative examples that highlight computational inefficiencies in healthcare computational systems given the asynchronous nature of related and interdependent computing systems. As one example, knee replacement patients interact with multiple hospital computer systems, including physiotherapy scheduling, radiology, laboratory, pharmacy, bed management, and meal scheduling, each maintaining independent databases with periodic synchronization. Post-operative non-compliance—missed physiotherapy, delayed medication adherence, or untracked recovery milestones—triggers repeated, asynchronous updates that propagate inconsistencies across these systems. Scheduling engines for physiotherapy and follow-up care accumulate erroneous timestamps as appointments are repeatedly canceled and rescheduled, creating stale or conflicting entries that require manual override. Radiology and lab systems, processing redundant imaging and bloodwork orders for preventable complications, experience excessive query loads and data duplication, leading to indexing inefficiencies and degraded system performance. Bed management algorithms, relying on outdated discharge estimates, generate inaccurate bed availability reports, causing reallocation loops and delaying surgical admissions. Pharmacy and meal scheduling systems must continuously reconcile patient discharge status, discarding transactions and reprocessing resource allocation requests. As updates arrive out of sequence, systems fall out of synchronization, generating race conditions, failed state transitions, and computational overhead that bottleneck hospital-wide workflow execution. Notwithstanding this specific example, these challenges exist more broadly in various asynchronous interdependent computing environments.

### SUMMARY

An aspect of the specification provides a computer-implemented method for synchronizing state transitions across a plurality of asynchronous engines in a computing environment, the method including: receiving, via a synchronization engine, event data from at least one asynchronous engine, the event data including a timestamp and an engine identifier; determining whether the received event data affects state dependencies in one or more other asynchronous engines; querying the one or more affected asynchronous engines to retrieve their current state data; generating a synchronization plan based on the retrieved state data, the synchronization plan specifying state transitions or resource reallocations required for consistency; determining whether conflicts exist in the synchronization plan, and if so, resolving the conflicts automatically or escalating them for manual intervention; executing the synchronization plan across the plurality of asynchronous engines; validating whether the executed updates have been successfully applied; and propagating finalized state updates to ensure system-wide consistency across the plurality of asynchronous engines.

An aspect of the specification provides a method, wherein the asynchronous engines include at least one of a bed management engine, a physiotherapy scheduling engine, a pharmacy management engine, or a radiology engine.

An aspect of the specification provides a method, wherein receiving event data further includes assigning a priority level to each event based on event type and dependency impact.

An aspect of the specification provides a method, wherein querying affected asynchronous engines further includes retrieving associated historical state transitions to predict potential scheduling conflicts.

An aspect of the specification provides a method, wherein generating a synchronization plan includes dynamically reallocating resources across the asynchronous engines based on real-time system constraints.

An aspect of the specification provides a method, wherein determining whether conflicts exist includes detecting overlapping resource allocations, duplicate scheduling entries, or contradictory state transitions.

An aspect of the specification provides a method, wherein validating updates includes executing a test run of the synchronization plan before committing state changes.

An aspect of the specification provides a method, wherein propagating finalized updates further includes logging all state transitions in a centralized electronic health record system.

An aspect of the specification provides a method, the synchronization engine ensures that discharge readiness is confirmed after completion of physiotherapy as logged by a physiotherapy scheduling engine.

An aspect of the specification provides a method, wherein in a healthcare use case, the synchronization engine prevents a bed reassignment from occurring until all dependent post-operative processes, including medication reconciliation, have been validated.

An aspect of the specification provides a computer-implemented method for managing task-based workflows in an asynchronous computing environment, the method including: receiving, via a workflow management engine, event data corresponding to a task assigned to an entity, the event data including a timestamp and an entity identifier; delivering a task workflow to the entity via a computing terminal; receiving input indicating workflow progress from the entity; determining whether the received workflow progress input satisfies task completion criteria; upon satisfying the task completion criteria, updating the event data to indicate task completion; upon failure to satisfy the task completion criteria, updating the event data with an exception state; and propagating the updated event data to dependent systems for further action.

An aspect of the specification provides a method, wherein the computing terminal includes a mobile device, a workstation, or a kiosk configured for task workflow presentation.

An aspect of the specification provides a method, wherein the task workflow includes a sequence of dependent steps, wherein each subsequent step is only presented upon successful completion of a prior step.

An aspect of the specification provides a method, wherein determining whether workflow progress satisfies task completion criteria includes verifying task completion against an external data source.

An aspect of the specification provides a method, wherein upon detecting an exception state, triggering a notification to a supervisor or administrator for intervention.

An aspect of the specification provides a method, wherein upon task completion, updating an associated scheduling system to reflect readiness for subsequent workflows.

An aspect of the specification provides a method, wherein the task workflow is dynamically adjusted based on external conditions or real-time system changes.

An aspect of the specification provides a method, further including issuing reminders if a task is not completed within a predefined timeframe.

An aspect of the specification provides a method, wherein the task workflow includes a rehabilitation program requiring data entry confirming completion of physiotherapy exercises before discharge processing can proceed.

An aspect of the specification provides a method preventing scheduling of patient discharge until a medication reconciliation task has been confirmed as complete within the pharmacy management engine.

### BRIEF DESCRIPTION OF THE FIGURES

The present specification includes the attached Figures, in which:

FIG. 1 shows a prior art system of asynchronous computing environments.

FIG. 2 shows a system for synchronization across asynchronous interdependent computing environments.

FIG. 3 shows a schematic diagram of a non-limiting example of internal components of the synchronization engine of FIG. 2.

FIG. 4 shows a schematic diagram of a non-limiting example of a stack of components associated with the synchronization engine of FIG. 2.

FIG. 5 shows a flowchart depicting a method for synchronization across asynchronous interdependent computing environments.

FIG. 6 shows a flowchart depicting a method for deploying workflows within the system of FIG. 2.

FIG. 7 is a schematic representation of healthcare management system.

FIG. 8 is a schematic representation of workflow through the system of FIG. 5.

FIG. 9 is a schematic representation of further workflow through the system of FIG. 5.

### DETAILED DESCRIPTION

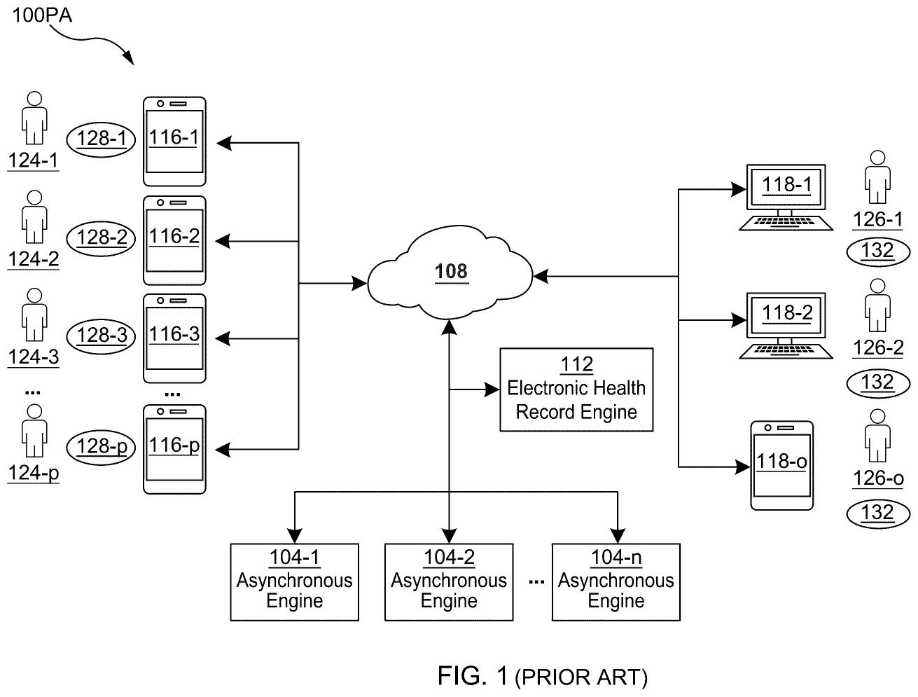

FIG. 1 illustrates various prior art asynchronous interdependent computing environments, indicated generally as prior art system 100PA. System 100PA comprises a plurality of asynchronous interdependent engines 104-1, 104-2, . . . 104-n (collectively referred to as engines 104 and generically as engine 104). Engines 104 represent asynchronous interdependent hospital subsystems, including, by way of non-limiting example, a physiotherapy scheduling engine 104-1, radiology engine 104-2) laboratory management engine(104-3, pharmacy management engine 104-4, and bed management engine 104-5. Each engine 104 maintains its own database and internal state, with periodic synchronization to an Electronic Health Record (EHR) engine 112, which serves as the central repository for patient data.

Network 108 enables communication between engines 104, a plurality of patient terminals 116, healthcare provider terminals 118, and administrator terminals 118. Patient terminals 116, which can include mobile devices, provide limited access to EHR engine 112, allowing patients 124 to authenticate via identifier objects 128 to view test results, appointment schedules, and pre-operative and/or basic discharge instructions. Healthcare provider terminals 118, operated by administrators 126, enable access to EHR engine 112 and various subsystems 104, permitting manual updates and review of patient status. Administrator terminals 118, linked to corresponding administrators 126 via identifier objects 132, facilitate system oversight, discharge authorization, and manual coordination between subsystems 104. Administrators 126 may include any hospital employee or staff member, such as doctors, nurses, technicians, and administrative staff.

Identifier objects 128 and 132 ensure secure authentication of patients 124 and administrators 126, respectively, to EHR engine 112 and/or relevant engines 104. Each identifier object 128 uniquely associates a patient 124 with a patient terminal 116, enabling controlled access to specific subsets of medical records stored in EHR engine 112. Similarly, each identifier object 132 links an administrator 126 to an administrator terminal 118, enforcing role-based access permissions for hospital subsystems 104, such as physiotherapy scheduling engine 104-1, radiology engine 104-2, laboratory management engine 104-3, and pharmacy management engine 104-4.

Identifier objects 128 and identifier objects 132 may be implemented as secure digital authentication tokens, such as cryptographic keys, biometric identifiers, RFID-based credentials, or session-based authentication objects. These objects 128 and objects 132 can effect authentication status with at least EHR engine 112. These objects propagate credentials to at least EHR engine 112. However, in prior art hospital workflow systems, identifier objects 128 and identifier objects 132 maybe session-bound to a single subsystem, requiring re-authentication when transitioning between engines 104 or EHR engine 112. This fragmented authentication model may result in increased computational overhead, redundant authorization checks, and inconsistent access states across interdependent systems. In cases of asynchronous data updates this can lead to mismatched session states, causing access control conflicts and forcing manual intervention to resolve authentication errors.

Furthermore, in prior art system 100PA, each engine 104 operates independently and asynchronously relative to other engines 104 and to EHR engine 112. As a result, delayed updates, conflicting state information, and redundant processing occur due to missed dependencies between interdependent engines 104. These inconsistencies arise from factors such as unstructured discharge coordination, redundant administrative actions, and incomplete adherence to scheduled post-discharge activities.

For example, if physiotherapy scheduling engine 104-1 reschedules a rehabilitation session to the following day due to a missed appointment by patient 124-1, bed management engine 104-5 may still allocate the corresponding bed to another patient 124-2, assuming discharge readiness of patient 124-1. However, because rehabilitation is a discharge requirement, the bed must be reallocated to its original patient 124-1, forcing last-minute reassignment of hospital resources and triggering additional state updates across the system 100PA.

Similarly, just as the bed management engine 104-5 must waste computational resources to reassign the bed to patient 124-1 back from patient 124-2, other hospital engines 104 may experience a domino-effect that drains their computing resources. For example, radiology engine 104-2 may have already assigned imaging resources to patient 124-2 under the assumption that patient 124-1 had completed the necessary recovery steps for discharge. However, because the missed rehabilitation session delays this progression, patient 124-1 may still require follow-up imaging before discharge, forcing radiology engine 104-2 to dedicate computational resources to reallocate scheduling for patient 124-1. Similarly, laboratory management engine 104-3 may have scheduled lab tests for patient 124-2 under the assumption that patient 124-1's post-op bloodwork was completed and no longer needed. In reality, patient 124-1's discharge delay may require laboratory management engine 104-3 to reallocate lab processing resources, further increasing resource contention. As these updates are non-deterministic and occur out of sequence, they contribute to redundant scheduling conflicts within computational engines 104, increasing query loads across engines 104, and leading to potential database inconsistencies within EHR engine 112.

In aggregate, asynchronous state propagation across engines 104 can introduce race conditions, inconsistent system states, and increased manual reconciliation efforts. The accumulation of these inefficiencies creates processing bottlenecks, further congesting system resources and increasing overall computational overhead. It will be understood that the computing resource inefficiencies scale exponentially for every exception event that occurs across prior art system 100PA.

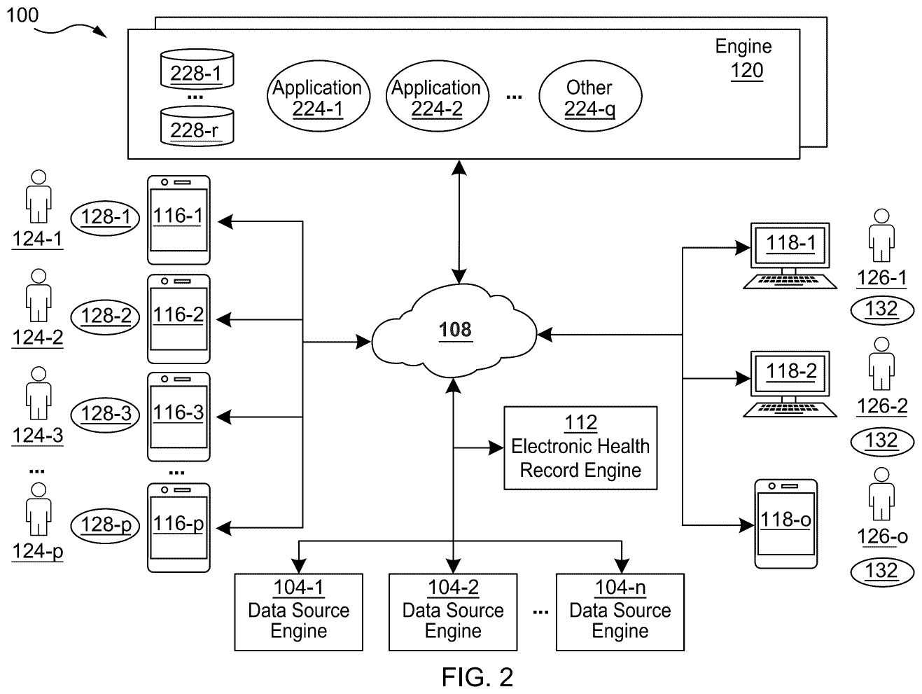

Referring now to FIG. 2, a synchronization system for asynchronous interdependent computing environments is indicated generally at system 100. System 100 includes many of the same elements as prior art system 100PA of FIG. 1, but further introduces synchronization engine 120, which facilitates real-time coordination across engines 104, electronic health record (EHR) engine 112, and user terminals 116 and 118.

System 100 operates within an asynchronous computing environment where independent computing engines 104 manage distinct operations and datasets. These engines 104 include, by way of non-limiting example, a physiotherapy scheduling engine 104-1, a radiology engine 104-2, a laboratory management engine 104-3, a pharmacy management engine 104-4, and a bed management engine 104-5. Additional engines 104-n, not shown, are contemplated. Each engine 104 maintains its own internal state and periodically synchronizes, via engine 120, with EHR engine 112 which serves as a centralized repository for patient data. Unlike system 100PA, which relies on periodic updates that may lead to outdated, conflicting, or redundant data states, system 100 introduces engine 120 to dynamically coordinate interdependencies across these engines 104.

Synchronization engine 120 comprises a plurality of applications 224, each performing distinct computational functions. Application 224-1 executes real-time synchronization logic across engines 104, ensuring state consistency across interdependent computing systems. Application 224-2 facilitates workflow management and coordination, enabling structured task execution for patient-related workflows, while application 224-q represents additional or extensible functions within engine 120, allowing for adaptable integration into various computing environments.

Network 108 facilitates communication amongst engines 104, EHR engine 112, and user terminals 116 and 118. Patient terminals 116, which may include mobile devices, enable patients 124 to interact with system 100, access relevant health data, and complete workflow-related actions as required. Healthcare provider terminals 118, operated by administrators 126, provide system oversight, direct engagement with engines 104, and manual coordination in cases where automated synchronization encounters conflicts. Each administrator 126 is uniquely identified via identifier objects 132, ensuring secure authentication and access control.

Identifier objects 128 and 132 enforce secure authentication mechanisms within system 100. Identifier object 128 uniquely associates a patient 124 with patient terminal 116, enabling controlled access to specific data records within EHR engine 112. Identifier object 132 links an administrator 126 to administrator terminal 118, ensuring role-based access to hospital subsystems 104 such as physiotherapy scheduling engine 104-1, radiology engine 104-2, and laboratory management engine 104-3.

In contrast to system 100PA, where identifier objects 128 and 132 may be session-bound to a single subsystem, system 100 facilitates continuous authentication propagation across engines 104. This reduces redundant authentication requests, mitigates access control conflicts, and ensures persistent session states across interdependent computing environments.

The integration of synchronization engine 120 within system 100 enables automated reconciliation of asynchronous state transitions across engines 104, ensuring coherent, real-time updates that prevent scheduling conflicts, redundant computational overhead, and inconsistencies in EHR engine 112.

Databases 228 store structured and unstructured data for applications 224, enabling persistent access to synchronization records, workflow states, and historical system interactions. In some implementations, databases 228 may also maintain cached copies of portions of data stored within engines 104, optimizing data retrieval latency and reducing query burdens across system 100.

Administrator terminal 118 allows administrators 126 to configure execution parameters for engine 120 and its associated applications 224, defining rules for synchronization priority, conflict resolution policies, and data reconciliation strategies. Identifier object 132 ensures secure access control, preventing unauthorized modifications to workflow automation logic.

System 100 thereby provides a computational framework for maintaining real-time synchronization across asynchronous interdependent computing environments, reducing computational overhead, improving workflow efficiency, and enabling consistent state management across engines 104. Having described an overview of system 100PA, it is useful to comment on the hardware infrastructure of system 100PA.

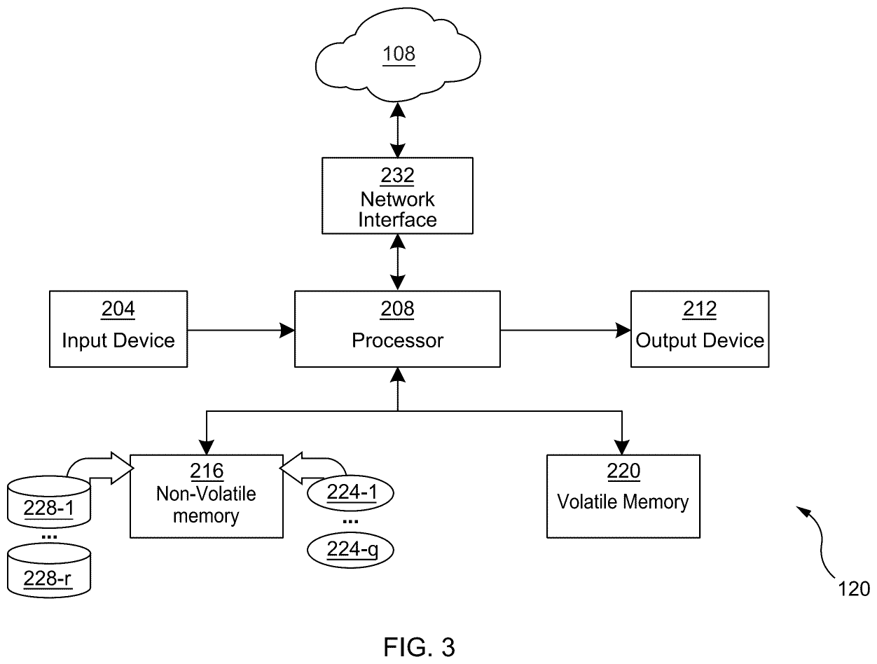

FIG. 3 shows a schematic diagram of a non-limiting example of internal components of engine 120. Engine 120 can include at least one input device 204. Input device 204 may include traditional input mechanisms like keyboards or mice. Output device 212 may be a display or could be a speaker for providing real-time feedback. In the context of system 100, one of the administrator terminals 118 would generally serve as a human-interface of keyboard, mouse (input devices) and display (output devices) on behalf of engine 120, with engine 120 omitting local versions of same, while network interface 232 monitors data streams over network 108 and sends signals over network 108 to control various other nodes of system 100, thus obviating the need for a local input device 204 or output device 212 at engine 120, notwithstanding their presence in FIG. 3.

Processor 208 may be implemented as a plurality of processors, one or more multi-core processors, or specialized hardware accelerators, such as Graphics Processing Units (GPUS), Tensor Processing Units (TPUs), or similar parallel processing units optimized for handling large-scale data and complex machine learning models. In certain embodiments, processor 208 may include a memory-centric or near-memory compute architecture, where processing elements are co-located with memory cells to minimize data transfer latency and power consumption. Processor 208 may be configured to execute different programming instructions, including those optimized for AI and machine learning tasks, responsive to input received via one or more input devices 204 and to control one or more output devices 212 to generate output on those devices.

To fulfill its programming functions, processor 208 is configured to communicate with one or more memory units, including non-volatile memory 216 and volatile memory 220. Non-volatile memory 216 can be based on any persistent memory technology, such as an Erasable Electronic Programmable Read-Only Memory (“EEPROM”), flash memory, solid-state hard disk (SSD), other types of hard disks, or combinations thereof. In embodiments using a memory-centric architecture, memory 216 may include processing units embedded within or adjacent to memory cells to reduce latency and improve energy efficiency in data handling. Non-volatile memory 216 may also be described as a non-transitory computer-readable medium, with multiple types of non-volatile memory 216 provided as needed.

Volatile memory 220 can be based on any random access memory (RAM) technology, such as Double Data Rate (DDR) Synchronous Dynamic Random-Access Memory (SDRAM). In certain embodiments, volatile memory 220 may incorporate high-speed, low-latency configurations. Other types of volatile memory 220, such as Low-Power DDR (LPDDR) or High-Bandwidth Memory (HBM), are also contemplated to optimize performance in high-computation environments.

Processor 208 also connects to network 108 via a network interface 232. As noted, network interface 232 can also be used to connect another computing device that has an input and output device (e.g. administrator terminal 118), thereby obviating the need for input device 204 and/or output device 212 altogether. The network interface 232 facilitates the transmission of interaction data streams from dynamic transaction management engines 104, terminals 116, and administrator terminal 118 via network 108, enabling real-time adjustments to Engine 120 based on evolving interaction sequences.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224. As discussed further below, application 224-1 includes executing state synchronization and application 224-2 includes workflow automation. Applications 224 may additionally include machine learning models or NLP modules configured for training and deployment of virtual interaction profiles. Applications 224 also include executable code for the various methods, and their variants, described herein. Databases 228 can include the various machine learning models developed, trained and maintained herein.

The infrastructure of engine 120, or a variant thereon, can be used to implement any of the computing nodes in system 100, including engines 104, and terminals 116 and terminals 118.

By the same token, a plurality of Engines 120 may be provided. Overall, the engines 104 and/or engine 120 and other nodes in system 100PA may be implemented using cloud computing platforms such as Microsoft Azure™ or Amazon Web Services (AWS)™.

Furthermore, one or more of the engine nodes in system 100PA (e.g. Engine 120, dynamic transaction management engines 104) may also be implemented as virtual machines and/or with mirror images to provide load balancing.

A person of skill in the art will recognize that the core elements of processor 208, input device 204, output device 212, non-volatile memory 216, volatile memory 220 and network interface 232, as described in relation to the server environment of Engine 120, have analogues in the different form factors of client machines such as those that can be used to implement terminals 116, administrator terminal 118 and execution engine 140.

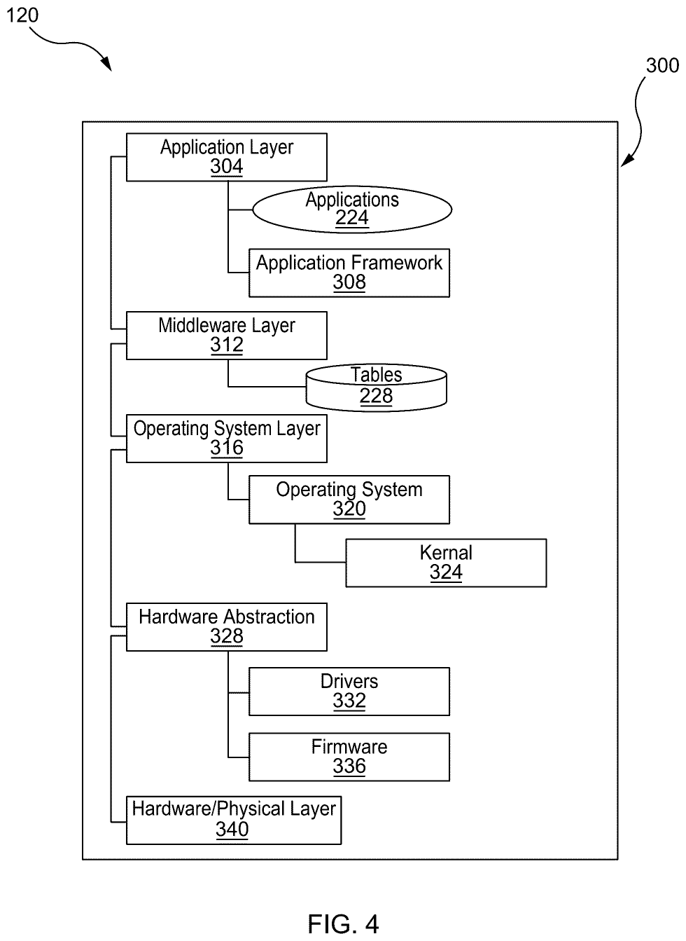

FIG. 4 provides a schematic representation of engine 120, illustrating the detailed view of a stack 300 employed in the computing environment of engine 120. Stack 300 depicts the different layers involved in the operation of engine 120, from the application layer 304 down to the physical hardware layer 340.

At the highest level, the application layer 304 encompasses various applications 224 and application frameworks 308. Applications 224 may include AI-specific software programs such as machine learning frameworks (e.g., TensorFlow, PyTorch) that perform training and deployment tasks for virtual interaction profiles. Application frameworks 308 provide libraries and tools that streamline the development and execution of these AI models.

Beneath the application layer is the middleware layer 312, which includes tables 228 and other middleware components. Middleware 312 serves as an intermediary, providing essential services like database management and data processing capabilities. Examples of middleware include database management systems and web servers that support data exchanges between various components of system 100PA.

The operating system layer 316 consists of the operating system 320 and kernel 324. The operating system 320 manages hardware resources and provides foundational services to applications 224, while the kernel 324 handles core system operations, facilitating efficient communication between hardware and software components.

The hardware abstraction layer 328 includes drivers 332 and firmware 336. The hardware abstraction layer 328 facilitates low-level system interactions, ensuring that scheduling updates and resource allocations from applications 224-1 and 224-2 are efficiently propagated through system 100. Drivers 332 allow the operating system 320 and other software to communicate with hardware devices shown in FIG. 3, such as input device 204, output device 212, and network interface 232. Firmware 336 enables low-level control of the hardware components in the physical hardware layer 340, ensuring smooth operation and integration with the software stack.

At the base of the stack is the hardware and physical layer 340 of engine 120, which encompasses physical components like the input device 204, processor 208, non-volatile memory 216, volatile memory 220, and network interface 232. This layer can provide the processing power and storage capacity required for, if applicable, training AI models and executing real-time interactions, including configurations with near-memory compute architectures to support high-speed inference tasks.

Stack 300 illustrates how the different layers interact within the computing environment of engine 120. Each layer is interdependent, relying on the services and capabilities of the layer below it, forming a cohesive system that powers the training processes and real-time adaptability of engine 120. This layered structure allows the Engine 120 to handle the complex requirements of engines 104, terminals 116, and agent terminals 140 within system 100PA.

The stack 300 in FIG. 4 is adaptable across various computing environments, including server infrastructures for engines 104, EHR engine 112, terminals 116, administrator terminal 118. Whether implemented in a traditional server environment or as virtual machines on cloud platforms like Microsoft Azure™ or Amazon Web Services (AWS)™, the described layers of stack 300 provide a robust framework for managing and executing software applications 224 and middleware components like tables 228.

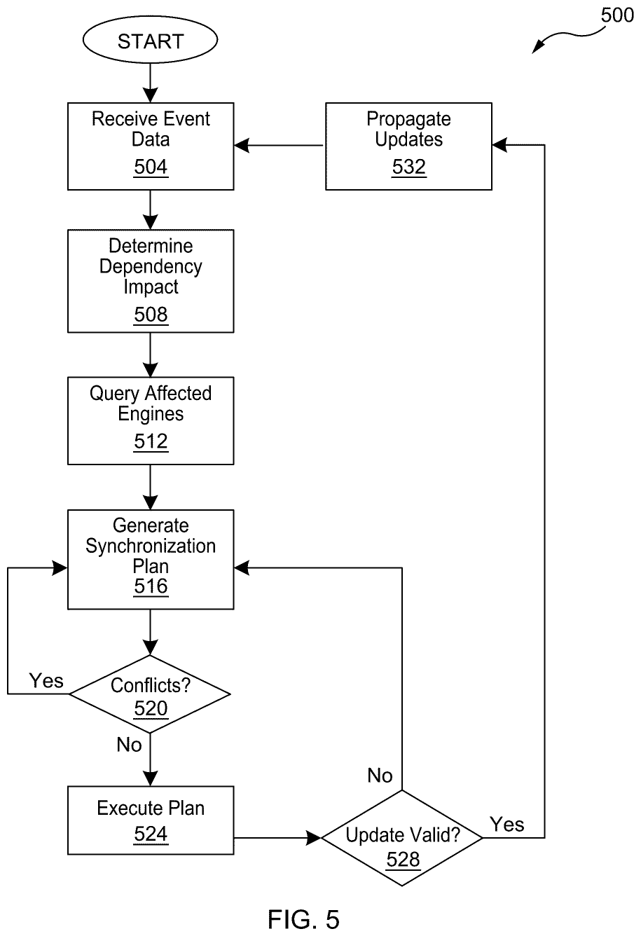

FIG. 5 shows a flowchart depicting a method for synchronization across asynchronous computing environments, indicated generally at 500. Method 500 can be implemented on system 100, though persons skilled in the art may implement variations thereof, including omitting certain blocks, performing steps in parallel, or reordering the sequence based on system configurations. For explanatory purposes, method 500 is described in the context of system 100, where it is implemented via application 224-1 within engine 120 and interacts with other nodes of system 100, as illustrated in FIG. 2.

Block 504 comprises receiving event data from at least one asynchronous engine 104. Events may be generated by subsystems such as bed management engine 104-5, physiotherapy scheduling engine 104-1, radiology engine 104-2, laboratory management engine 104-3, and pharmacy management engine 104-4. Each received event is tagged with a timestamp and engine identifier to maintain event ordering and traceability within synchronization engine 120.

Block 508 comprises determining dependency impact based on the received event data. Engine 120 evaluates whether the received event affects state dependencies across other engines 104. If no dependencies exist, engine 120 proceeds with standard event propagation. If dependencies exist, further analysis is required.

Block 512 comprises querying affected engines 104 for their most recent state data. For example, if an event indicates a delayed physiotherapy session, engine 120 queries bed management engine 104-5, radiology engine 104-2, and laboratory management engine 104-3 to determine if corresponding resources were already allocated elsewhere based on an outdated discharge assumption.

Block 516 comprises generating a synchronization plan based on the queried data. Engine 120 compares the received event against the current state of affected engines 104 to determine the required modifications. The synchronization plan may include dynamically reallocating resources, rescheduling procedures, or flagging inconsistencies for manual resolution.

Block 520 comprises determining whether conflicts exist in the synchronization plan. If conflicts exist—such as two patients being assigned the same imaging slot or a bed being over-allocated—engine 120 applies conflict resolution logic or escalates the issue for manual intervention. If no conflicts exist, method 500 proceeds with execution.

Block 524 comprises executing the synchronization plan across the affected engines 104. System 100 updates state transitions, reallocates resources as required, and ensures that affected subsystems reflect the corrected state.

Block 528 comprises validating whether the updates have been successfully applied. If validation fails due to race conditions, stale data, or conflicts detected during execution, method 500 loops back to block 516 to regenerate the synchronization plan. If validation succeeds, method 500 proceeds with finalizing updates.

Block 532 comprises propagating finalized updates to all dependent engines 104. Once synchronization is complete, system 100 ensures that all affected components reflect a consistent, updated state, reducing computational overhead and preventing redundant scheduling conflicts.

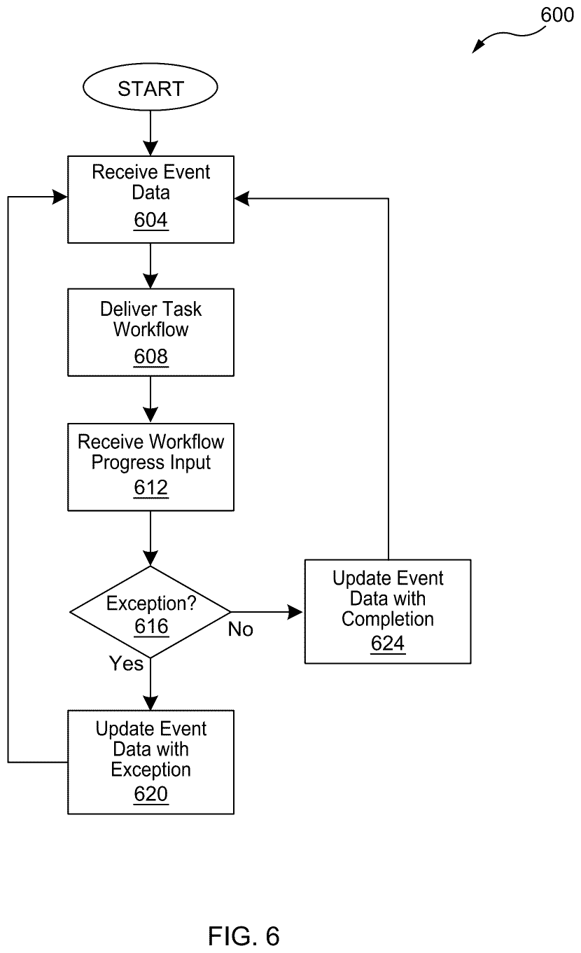

FIG. 6 shows a flowchart depicting a method for workflow management within asynchronous computing environments, indicated generally at 600. Method 600 can be implemented on system 100, though persons skilled in the art may implement variations thereof, including omitting certain blocks, performing steps in parallel, or reordering the sequence based on system configurations. For explanatory purposes, method 600 is described in the context of system 100, where it is implemented via application 224-2 within engine 120 and interacts with other nodes of system 100, as illustrated in FIG. 2.

Block 604 comprises receiving event data related to workflow progression. This event data may originate from an asynchronous engine 104, such as physiotherapy scheduling engine 104-1, bed management engine 104-5, or pharmacy management engine 104-4. Event data may include updates regarding scheduled tasks, patient interactions with terminal 116, or administrative actions received via terminal 118. Each received event is assigned a timestamp and associated with a unique identifier object 128 or 132 to track workflow participation.

Block 608 comprises delivering a task workflow based on the received event data. Engine 120 determines relevant workflow actions required for the corresponding entity, such as presenting a rehabilitation task to a patient 124 via patient terminal 116. The task workflow is dynamically structured to account for real-time system conditions, ensuring that dependent tasks are sequenced appropriately to maintain synchronization across engines 104.

Block 612 comprises receiving workflow progress input. Patients 124 or administrators 126 confirm task completion via terminal 116 or 118, respectively. The received input is validated against system records maintained by EHR engine 112 or other engines 104. For example, if a rehabilitation session is required for discharge, the system checks whether physiotherapy scheduling engine 104-1 has logged the session before accepting the patient's confirmation.

Block 616 comprises determining whether an exception has occurred. An exception is identified when the received workflow progress input conflicts with system records or is otherwise invalid. Examples of exceptions include a patient 124 claiming to have completed a rehabilitation session that has not been recorded by physiotherapy scheduling engine 104-1, a missed medication pickup logged by pharmacy management engine 104-4, or an unverified lab test result from laboratory management engine 104-3.

Block 620 comprises updating event data with an exception when a workflow deviation is detected. If an exception is identified in block 616, engine 120 logs the discrepancy and may trigger corrective actions. These actions may include notifying administrators 126, rescheduling pending tasks, or flagging conflicts for manual resolution. Exception data is propagated to dependent engines 104 to prevent erroneous state transitions.

Block 624 comprises updating event data with completion when no exceptions are detected. If the workflow progress input is validated successfully, engine 120 finalizes the task completion and updates relevant subsystems accordingly. This may include marking a rehabilitation session as complete within physiotherapy scheduling engine 104-1, triggering a bed release in bed management engine 104-5, or confirming a medication pickup in pharmacy management engine 104-4. The finalized task state is propagated to ensure system-wide synchronization.

While the foregoing discussion of method 500 and method 600 introduces an overview with certain high level examples, it is useful to provide some specific use-cases to further elaborate these teachings.

Consider a non-limiting example of a knee replacement patient 124-1 recovering in a hospital setting. Upon completion of surgery, patient 124-1 is assigned, via its terminal 116-1, a structured rehabilitation program, which includes a mandatory physiotherapy session before being cleared for discharge. This workflow is managed by method 600, which ensures that its terminal 116-1 is presented with required recovery tasks and that completion is validated before discharge readiness is confirmed by engine 120.

When patient 124-1 is scheduled for a physiotherapy session, physiotherapy scheduling engine 104-1 generates an event update, triggering block 604 of method 600, which receives the event data and registers the upcoming session as a workflow task, with the display of its terminal 116-1 being controlled accordingly. In block 608, synchronization engine 120 delivers the task workflow to patient 124-1 via patient terminal 116, presenting an actionable prompt to complete the rehabilitation session. The patient's progress is then monitored, and upon session completion, patient 124-1 submits a confirmation input via terminal 116-1, which is processed in block 612.

At this point, block 616 determines whether an exception has occurred. If physiotherapy scheduling engine 104-1 logs the session as completed, no exception is detected, and the workflow progresses to block 624, where the event data is updated to reflect successful completion. Conversely, if there is a discrepancy—such as patient 124-1 failing to attend the session or submitting a confirmation prematurely—block 620 logs the event as an exception, requiring intervention before discharge readiness can be finalized.

With physiotherapy completion validated, method 500 begins updating dependent engines 104 to ensure synchronized resource allocation. At this stage, bed management engine 104-5 has been tracking patient 124-1's expected discharge readiness, contingent upon completing physiotherapy. With the updated physiotherapy completion status now logged, synchronization engine 120 executes block 516 to generate a synchronization plan that transitions patient 124-1 into discharge processing. This enables bed management engine 104-5 to formally reclaim the bed for a new patient 124-2. Similarly, pharmacy management engine 104-4 ensures that inpatient medication orders are closed out before allowing medication pickup for discharge.

During this synchronization process, block 520 checks for potential conflicts. If patient 124-1's bed was still flagged as occupied due to an earlier dependency check, synchronization engine 120 dynamically resolves the conflict by updating the system state in block 524, ensuring that bed management engine 104-5 correctly reflects the discharge transition. Once all subsystems confirm the updates, block 528 validates that no inconsistencies exist across interdependent engines 104. If validation succeeds, block 532 propagates finalized updates to all relevant systems, allowing patient 124-1 to proceed with discharge.

Consider an alternate scenario in which patient 124-1 is expected to complete physiotherapy but fails to do so. When patient 124-1 attempts to confirm task completion via terminal 116-1, the physiotherapy scheduling engine 104-1 does not log the session as completed. At block 616, synchronization engine 120 detects the inconsistency and determines that an exception has occurred. As a result, method 600 proceeds along the “Yes” branch to block 620, where the event data is updated with an exception flag.

The detection of this exception triggers a cascade of computational updates across system 100. Since discharge is contingent upon successful physiotherapy, synchronization engine 120 prevents bed management engine 104-5 from reallocating the bed to patient 124-2. Additionally, radiology engine 104-2 and laboratory management engine 104-3, which may have preemptively scheduled follow-up assessments for patient 124-1, must now defer these tasks until physiotherapy completion is confirmed. This ensures that dependent workflows are not prematurely executed based on incomplete recovery data.

The flagged exception may prompt one of several automated or manual interventions. Synchronization engine 120 may trigger an alert to an administrator 126 via terminal 118, notifying them of the incomplete task and prompting manual review. Alternatively, engine 120 may issue a reminder to patient 124-1 via terminal 116-1, instructing them to reschedule and complete the session before a revised discharge evaluation can proceed.

By enforcing exception handling at block 616, method 600 ensures that discharge workflows remain synchronized with actual patient recovery progress. At the same time, method 500 prevents erroneous resource allocations, reducing inefficiencies and maintaining a dynamically updated computational state across engines 104.

The interaction between method 600 and method 500 ensures that hospital workflows remain synchronized at a computational level. By enforcing structured task completion via method 600 and dynamically managing system-wide resource allocation via method 500, synchronization engine 120 prevents scheduling conflicts, reduces redundant processing, and optimizes real-time state management across engines 104. This allows hospital operations to maintain efficiency while minimizing the need for manual intervention.

To give a further illustrative example, consider a preoperative workflow where patient 124-1 is scheduled for an upcoming knee replacement surgery. Unlike the postoperative rehabilitation scenario, this workflow involves pre-admission preparation tasks, such as ensuring that the patient arrives at the hospital with essential personal items and completes necessary preoperative instructions. This scenario is managed through method 600, ensuring that patient terminal 116-1 provides structured task guidance and that completion is validated before hospital admission.

Prior to surgery, synchronization engine 120 triggers block 604 of method 600 to receive preoperative workflow event data. This event data is received at block 604 from one or more scheduling engines 104 (not explicitly labelled in FIG. 2) that track upcoming surgical admissions. Based on this data, block 608 delivers a structured preoperative checklist to patient 124-1 via patient terminal 116-1. The checklist may include instructions such as “Bring comfortable clothing for post-surgery rehabilitation,” “Pack a storage bag for personal belongings,” or “Ensure transportation arrangements for discharge.”

As patient 124-1 completes these preparatory steps, they confirm progress via terminal 116-1, triggering block 612, where synchronization engine 120 receives workflow progress input. If patient 124-1 confirms that all required items have been packed and all preoperative instructions have been followed, block 616 checks for exceptions. If all checklist items are validated (e.g., the system detects that patient 124-1 has acknowledged the checklist in the required timeframe), the workflow proceeds to block 624, where event data is updated to reflect successful completion.

However, if patient 124-1 fails to complete any critical checklist items before admission—such as not bringing required assistive devices or failing to adhere to preoperative fasting guidelines—block 616 identifies an exception, causing block 620 to log the event as incomplete. This triggers a corrective intervention within synchronization engine 120.

If an exception is logged, method 500, working in conjunction with the results from method 600, ensures that dependent hospital resources remain properly allocated. For example, bed management engine 104-5 may delay final bed assignment if patient 124-1 is not yet ready for admission. Similarly, pharmacy management engine 104-4 may defer pre-surgical medication orders if fasting compliance is uncertain. Synchronization engine 120 executes block 516 to generate a synchronization plan that either reschedules the surgery, issues patient reminders, or escalates the issue to administrators 126 for manual review.

At this stage, method 500 enters block 520 to check for conflicts. If patient 124-1 was scheduled to occupy a preoperative holding area that now must be reassigned, synchronization engine 120 dynamically updates system state in block 516 (Generate Synchronization Plan), ensuring that pre-surgical workflows are adjusted in real-time. If the issue is resolved—such as the patient confirming checklist completion after receiving a system-generated reminder—method 500 validates the updates at block 528 (Updates Valid?) and propagates final synchronization data at block 532 (Propagate Updates across engines 104 and EHR engine 112).

The integration of method 600 for structured preoperative task management and method 500 for resource synchronization ensures that hospital admissions proceed efficiently. By automating task tracking and dependency management, synchronization engine 120 minimizes scheduling conflicts, ensures accurate patient preparation, and reduces manual administrative oversight.

In view of the above it will now be apparent that variants, combinations, and subsets of the foregoing embodiments are contemplated. For example, the present specification may have broader application to Smart Traffic Systems, Personalized Online Learning (EdTech), and EV charging networks, where uncoordinated state transitions among interdependent asynchronous systems degrade overall efficiency. Consider a non-limiting example of a Smart Traffic System managing dynamic traffic light synchronization across an urban grid. Each intersection is governed by a traffic management engine 104, which operates independently but must periodically synchronize with adjacent intersections to optimize flow efficiency. Method 600 governs structured workflows assigned to individual users, such as a driver requesting a dedicated lane or a pedestrian seeking to cross a busy intersection, while method 500 ensures system-wide state consistency across all interdependent traffic signals.

For instance, when a pedestrian at an intersection presses a request button to cross, method 600 logs this input at block 604 and assigns them a structured crossing workflow. At block 608, synchronization engine 120 delivers an acknowledgment signal to pedestrian terminal 116, indicating when crossing will be permitted. If the pedestrian does not cross within the assigned window, method 600 evaluates the status at block 616, determining whether an exception—such as an abandoned request—has occurred. If an exception is logged at block 620, synchronization engine 120 updates the system state to clear the pending request. Otherwise, at block 624, the pedestrian's crossing is confirmed, and traffic resumes normal operation.

In parallel, method 500 ensures that this individual crossing workflow does not cause broader traffic inefficiencies. At block 516, synchronization engine 120 assesses whether the pedestrian crossing will impact other intersections—such as forcing a queue of vehicles to back up into an adjacent intersection. If a conflict is detected at block 520, synchronization engine 120 dynamically adjusts signal timings at block 524 before propagating the update at block 532. This two-method approach ensures that method 600 efficiently handles individual user workflows while method 500 maintains optimized traffic flow across the system.

Consider a non-limiting example of a Personalized Online Learning (EdTech) system, where students progress through coursework asynchronously while various subsystems manage scheduling, assessments, instructor availability, and certification tracking. Each subsystem functions independently but must remain synchronized to ensure smooth learning progression. Method 600 governs individualized learning workflows, ensuring that students receive tasks such as quizzes or assignments through terminal 116 (e.g., a learning management system dashboard). Meanwhile, method 500 manages real-time synchronization across engines 104, preventing conflicts such as students accessing future coursework before meeting prerequisite conditions.

For example, when a student reaches a quiz milestone, Assessment Engine 104-2 logs the event, triggering block 604 in method 600. The system then presents the quiz via block 608, awaiting student completion. Upon submission, the system determines the outcome in block 612. If the student achieves a passing score, block 624 updates event data with completion, allowing Lesson Scheduling Engine 104-1 to unlock the next module. If the student fails, block 616 detects an exception, triggering block 620 to log the failure and notify Instructor Availability Engine 104-3 to schedule remediation. Concurrently, method 500 ensures Certification & Progress Tracking Engine 104-5 reflects the latest course status, preventing premature certification issuance.

Throughout this process, Synchronization Engine 120 orchestrates real-time updates across engines 104. If multiple students require instructor assistance due to failed assessments, method 500 dynamically reallocates office hours to balance demand, ensuring efficient resource management. Additionally, Collaboration Engine 104-4 prevents students from joining team-based projects until prerequisites are met, avoiding mismatches in skill levels. By leveraging method 600 for individualized learning workflows and method 500 for global synchronization, the system optimizes personalized learning paths, maintains consistency across independent processes, and prevents inefficient or premature state transitions.

Consider a non-limiting example of an Electric Vehicle (EV) Charging Network, where multiple independent subsystems manage vehicle charging sessions, station availability, power grid demand, and payment processing. Each subsystem operates asynchronously but must synchronize to ensure efficient energy distribution and user access to charging stations. Method 600 governs individual EV driver workflows, such as scheduling a charging session via terminal 116 (e.g., a mobile app or in-vehicle infotainment system), while method 500 manages network-wide resource allocation, preventing station overloads and ensuring equitable power distribution.

In the Electric Vehicle (EV) Charging Network example, the system comprises multiple independent subsystems that work together to ensure efficient energy distribution, user access to charging stations, and grid stability. Each subsystem operates asynchronously but requires periodic synchronization to prevent station congestion, energy shortages, and billing errors. These subsystems function as engine 104 equivalents, each handling distinct aspects of the charging process.

Charging Station Availability Engine 104-1 tracks real-time availability of EV chargers at various locations and assigns charging slots to users based on demand and station capacity. Energy Demand Management Engine 104-2 works in parallel, coordinating with the power grid to balance electricity distribution, ensuring that peak-hour demand does not exceed local supply limits. To facilitate seamless transactions, Payment Processing Engine 104-3 manages transaction authorizations, pricing calculations based on usage, and payment confirmation upon session completion.

The system also incorporates Fleet & Reservation Management Engine 104-4, which handles reserved charging slots, dynamic pricing adjustments, and priority access for specific user groups, such as ride-share fleets or corporate EV pools. Finally, Vehicle Battery Health & Compatibility Engine 104-5 verifies whether a vehicle's battery can safely support the selected charging rate, preventing inefficiencies or potential system damage. By synchronizing these engines in real time through method 500, while assigning user-driven workflows through method 600, the system ensures optimal resource allocation and a seamless charging experience for all users.

When a driver schedules a charging session, Charging Station Availability Engine 104-1 logs the request, triggering block 604 in method 600. The system assigns a charging station via block 608 and presents the user with session details (e.g., expected wait time, pricing). Upon arrival, the driver plugs in their vehicle and confirms charging initiation via terminal 116 (mobile app or station UI), which is processed at block 612. If the vehicle is compatible and station power allocation is available, block 624 updates the event data to confirm charging has begun. If an issue arises—such as an incompatible charger or grid demand exceeding capacity—block 616 detects an exception, triggering block 620 to log the failure, notify the user, and reattempt allocation at a different station.

In parallel, method 500 ensures system-wide synchronization. If multiple high-power chargers in the same region request energy simultaneously, Energy Demand Management Engine 104-2 evaluates the load and prevents grid overdraw. If conflicts arise—such as multiple users competing for limited charging slots—block 520 in method 500 assesses priority based on Fleet & Reservation Management Engine 104-4. Once the updated allocation plan is finalized in block 524, Payment Processing Engine 104-3 calculates session costs and verifies user payment before method 500 propagates final updates via block 532. By dynamically balancing individual charging workflows (method 600) with network-wide energy and station availability (method 500), the system prevents inefficiencies such as station congestion, payment failures, or electricity shortages, ensuring smooth EV charging operations.

Furthermore, the present specification provides a method for users to understand and navigate the healthcare system to track discharge progression or lack of progression including notifying the user of discharge requirements that are required to be safely discharged as per medical advice and/or health authority.

The present specification provides a handheld device configured to wirelessly connect to interface with the electronic healthcare operating system which stores patient's health record to input and view user data wirelessly and specific information in patient's health record. Healthcare professionals manage patient's healthcare status into electronic healthcare record operating system (hardware and software) to monitor patient's progress/deterioration. This healthcare information is electronically transmitted into a checklist which a user (patient/family member) can access on their personal wireless device. This checklist is a list of discharge requirements based on healthcare providers, current best medical practice approved by physician and or health care authority. This checklist reflects the patient's health status and readiness for discharge base data received from the healthcare operating system. The discharge checklist is also reflected as progression bar. The more tasks completed/requirements met the more the progress bar moves towards 100%. 100% equals discharge, meaning all requirements of discharge are met. The checklist and progress bar can be updated in real time to reflect the information received the electronic healthcare record.

The user can also able to input data which will be transmitted into their electronic healthcare record which the healthcare professional will need to be aware of address, such as information missed by healthcare professional including but not limited to documenting bowel movements, fluid intake, when ride is available on day of discharge, if patient is losing, concerns about caregivers, housing, needing dressing supplies/equipment, need consult to social work, spiritual care, home care, placement, any other information that they want to share with their healthcare team that may impact their care.

The method can receive pre-existing health information from doctors and health care authorities as they will be linked to healthcare authority informative websites, where the user can access including but not limited to pre-operative instructions and checklists such as things to pack for surgery. As well the method can provide post discharge instructions will be based on patient healthcare record and physician instructions on an user's handheld device.

The present specification provides a communication tool that provides education and transparency for patients and their family/caregiver during the hospital discharge process. The patient/caregiver will be able to choose if they want to participate or not through a virtual agreement. At the first point of contact, the patient/caregiver will be asked to scan a QR code, which will direct the patient to download the app. The app will show the discharge process using a checklist targeted towards each specific surgical patient and provide access to pre-existing reading materials from health organizations early in the patient's hospitalization that are typically only provided at discharge. The health care team will work with the patient/caregiver to communicate the patient's journey from surgery to home. This will empower the patient/caregiver, acting as a guide to help make them more cognizant of their own health status and recognize what resources/support they may need to help them manage when they return home. The app will provide the patient/caregiver with the tools to address their concerns, fears, and expectations surrounding their hospitalization. The app will be linked to current health technologies, to communicate with the patient if they have any outstanding tests, if they have met their daily mobilization goals, and if they have any other barriers to being discharged. The app will also feature a colour-coded graphic to help the patient visualize their progress towards discharge and communicate a pending estimated date of discharge.

An aspect of the specification provides a method for evaluating a patients'readiness for discharge from hospital, the method including: receiving patient clinical information from EMR which may include but not limited to blood work, diagnostic information in patient's electronic medical record, and latest evidence practice for safe discharge and MD decision generating estimated date of discharge. A system implementing the method can be based on but limited to the patient clinical information in their EMR, user input, healthcare professional input identifies a needs and supports of patients; including housing, finances, equipment, home care support, family/friend support, where client lives (location), and previous ability to manage prior to discharge as well as long term medical term care plan; These needs/support can then estimate the date of patient discharge, based on effective discharge practice and associated with determining an estimated date of discharge at the future time for a patient, for receiving medical treatment at the treatment facility; dynamically determining, using the system, a patient assessment profile by: processing the patient clinical information to generate input data values; dynamically deriving weighting factors as an assessment of importance or relevance of the input data values and assigning discharge potential; deriving as output data values for the patient assessment profile using the input data values and the weighting factors, the output data values being a probability of an expert treatment decision for discharge the patient from a treatment facility and providing the and a visual representation of the discharge progress, the estimated date of discharge that can follow after the estimated medically stable time and/or the estimated treatment time; outputting the output values as clinical decision support information to trigger display on a user display device and, transmission of data from EMR and healthcare operating system (hardware and software) to the user's client device.

An aspect of the specification provides a method in further including: determining the patient's pre-morbid status, general health and co-morbidities as an additional input data value for the patient assessment profile can be considered when estimating estimated date of discharge.

An aspect of the specification provides a method further including continuously updating the patient assessment profile using a feedback loop based on additional input data values including medical information from health care professional including physicians, occupational therapists, physiotherapists, respiratory therapists, nurses, blood work and diagnostic results which makes healthcare data, changing configurations for the physician and healthcare facility based on best practice and updates for the one or more weighting factors on potential discharge/transfer to less acute care needs facility.

An aspect of the specification provides a method further including constructing and continuously validating the patient assessment profile and the input data values using current and future clinical best discharge practice.

An aspect of the specification provides a method further including receiving threshold data for a health care provider to update and customize the patient assessment profile, the weighting factors, and the input data values for the health care provider, the health care data, and other current existing health care metrics with healthcare facility.

An aspect of the specification provides a system for managing interactions with health care system, including of an interface configured to receive input from user and EMR.

An aspect of the specification provides that systems includes status and progress updates, pending discharge/tasks needed to complete for discharge to be complete or needed follow up requirements.

An aspect of the specification provides the system can allow for the health care team and families/caregivers to schedule family/discharge meetings.

An aspect of the specification provides the system can have a chat function where patients can make requests for non urgent communication. The chat can integrate into the medical operating system (hardware and software) of health care facility. The system can send and receive messages from the medical operative system.

An aspect of the specification provides a system that integrates into an EMR and operating system (hardware and software) that manages patients' electronic health record; thereby providing updated information to the user regarding their status and progression through the health care system.

An aspect of the specification provides a graphical interface that has a progress bar, which shows a graphical control element used to visualize the necessary steps/movement towards discharge from hospital. If discharge requirements are not met discharge workflow can be configured to stop, potentially reversing the workflow progress and this triggers another dashboard for higher level of care (such as intensive care unit /cute unit/Internal medicine, unit) which is in the case of a medically unstable patient. Similarly, medically stable patients may require long term care or rehab in a facility and in the case the discharge progress bar stops which triggers a long term/rehab dashboard.

An aspect of the specification provides a system that includes access to approved medical information, discharge summaries, pre-operative instructions, follow up inform, medications, hospital information and pending tests/consults.

An aspect of the specification provides a system that can produce an estimated date of discharge related to a specific calendar day which is based on patients'health status and potential date discharge. This can be visual seen on standard calendar.

In one aspect, the present disclosure includes a communication system for managing discharge planning. The system can include an interface configured to receive input from users, clickable drop-down menus, and the ability to update information such as the name of the hospital, date of surgery, and the surgeon's name. The system can follow a standard checklist/decision tree algorithm to evaluate patients' comprehensive conditions for adequate discharge arrangement. The system can communicate a checklist, tracking patient progress to discharge and recovery at home. It is a progress tracker see figure. The system can also communicate the patient's lack of progression towards discharge. For example, the patient is medically stable but is unable to manage their care needs without support. Or if the patient becomes medically unstable. The system can communicate tests, diagnostic, blood work, consults needed to follow, review medication, provide education material such as videos and discharge instructions. The system can communicate the estimated date of discharge based on input from the patient and the health care team. The system can assist the patient schedule transportation home in advance and this information can be communicated to the health team and the patient's ride. The system can be applied to surgical patients, medical patient, ICU patients, emergency patient, pediatric, obstetrical patients and their newborns, gynecology patients, mental health/addiction patients, day surgery patients, cardiology patients, oncology patients, ophthalmology patients, renal patients, Internal medical patients and palliative patients' dashboards. The system can be configured to transmit user information with existing health technology infrastructure to exchange key information with the patient/caregiver such as perioperative and preadmission, discharge instructions and the estimated date of discharge, follow up appointment, questions/concerns. The system can identify who needs to be involved in my discharge planning and communication with the healthcare team. The system can allow for patients to send links via email or texts sent to family/caregiver/support person with status updates. The system can allow non urgent messages regarding concerns to be received through secure chat from family/patient, directly to providers, who then can address them. such as patient preferences. The system can have a section for the patient to fill in their preferences, provide staff appreciation, report concerns with their care, and information about the hospital such as a map of hospital, parking information, food, etc. Additionally, there can be a section for caregivers with links to available resources in communities such as home care and support groups. The system can provide updated information regarding where the patient is on the waitlist placement/rehabilitation/respite. The system can provide a platform for scheduling meetings with family/health care team to discuss discharge planning.

Although traditional discharge practice can be useful in some instances, they can also be missed. For instance, some health care providers may follow best practice and use a discharge checklist and start discharge teaching upon admission, many do not and discharge teaching occurs right when a patient is leaving hospital. When this occurs, the patients may not understand how they can manage at home, and this leads to anxiety and unpleasant and/or stress for the user and then the patient is unable to hear any discharge teaching. This leads to re-admission and additional emergency visits. In contrast, early discharge planning that identifies the learning needs and concerns of the patient/caregiver has been shown to help improve patient adherence to follow-ups with their doctors, decrease the risk of medical errors, and decrease the risk of mortality. In this situation, the patient/family are more satisfied with the care and services they received. Traditional discharge planning does not provide a patient centre in any sort of an efficient manner.

The present disclosure provides a method to improve communication and interactions with the health care system during discharge/interactions with the health care system which obviates or mitigates at the current confusing states of discharge practice.

To try to solve the capacity issues within hospitals and decrease confusion for users, a discharge-focused mobile app on a smart device that can help improve communication and transparency between the patient/caregiver and the healthcare team early in a patient's hospitalization.

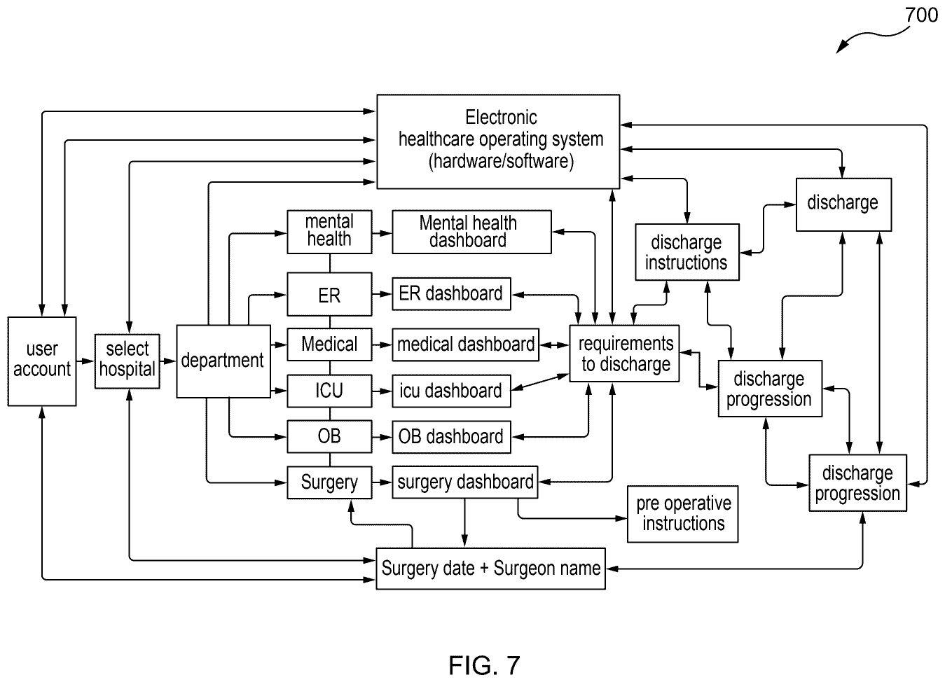

FIG. 7 is a schematic representation that illustrates aspects of system 100 and further elaborates on the interactions described in method 500 and method 600, providing additional context to the earlier teachings herein. It starts with the user's first point of contact, where the user creates a unique account. The next step they are then directed to select the hospital/healthcare facility; then the department (mental, ER, ICU, OB etc). This directs the user automatic to that specific department dashboard. Each dashboard provides specific information regard the users care and needs, as well as information and requirement to discharge and progress to discharge. At each stage information to delivered and received from electronic healthcare record (EMR) operating system to user. The flow of information from the user to EMR is ongoing and only stops when discharge occurs. It is an ongoing exchange of information share at every stage and interaction with EMR in both directions where users and healthcare providers who use EMR can exchange and communicate the users' health needs and status/progress.

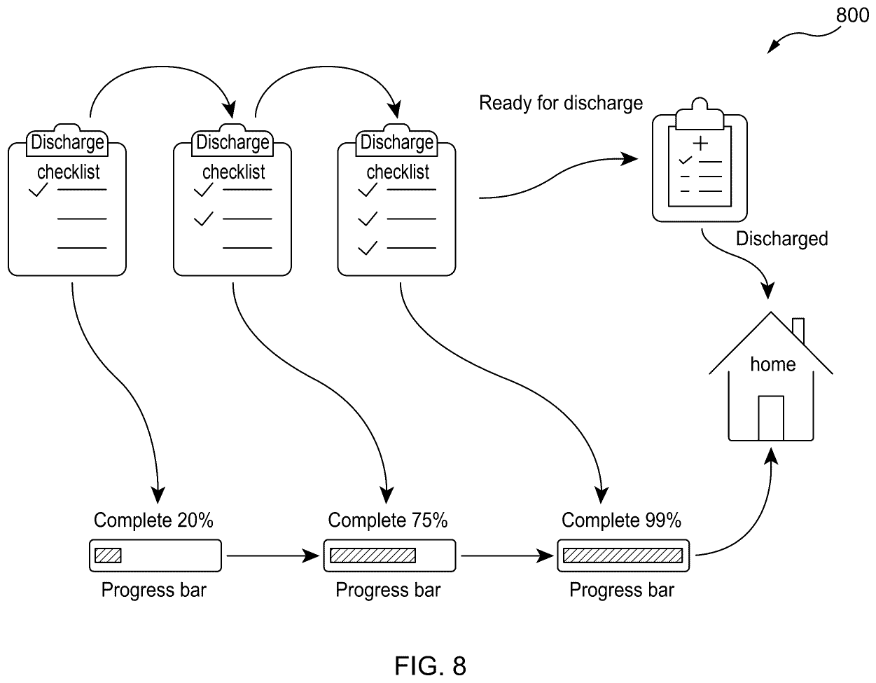

FIG. 8 shows a schematic representation of a workflow that a patient can follow through the healthcare system based on whether they are progressing or not progressing with the healthcare system as to readiness for discharge based on a discharge checklist. As items on the on-discharge checklist are completed items are marked off on the checklist. This is also reflected in in the discharge progress bar, as patient become closer to discharge the larger the percent of the bar is filled in. For example, 0% on progress bar reflects a new admission and user needs to have all tasks to be discharge. Whereas 100% means discharge ready all discharge tasks have been completed.

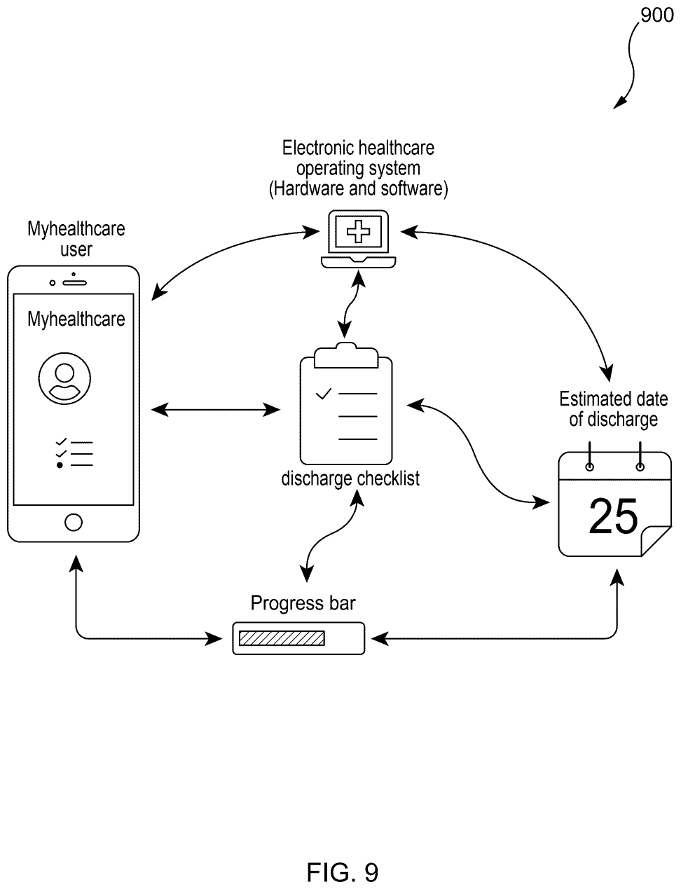

FIG. 9 is schematic diagram showing the workflow of user's health information at each stage through the pathway. The EMR is reflected in the discharge checklist based on user and EMR input, as the items on the checklist are complete it is reflected in the discharge progress bar. Furthermore, the user health information from EMR provides and estimated date of discharge, which reflects in the discharge checklist completed tasks and in turn discharge progress bar. This a continuous feedback loop between the user and the EMR. The progress bar graphic to help the user visualize their progress towards discharge and communicate specific tasks and or requirements towards a pending estimated date of discharge. The estimated date of discharge is visual seen as a date on the calendar.

The described embodiments may be implemented in various configurations of hardware and software, including but not limited to cloud-based environments, edge computing setups, or local server deployments, depending on the desired speed, scalability, and security requirements of the application. For instance, Engine 120 can be deployed as a distributed system across multiple data centers to support global travel operations, or as a localized solution for a specific market.

It is to be understood that one or more of the applications may include a machine learning studio platform with any desired related machine learning (ML) based algorithms and/or neural networks, and the like. The machine learning applications can utilize various algorithms, including but not limited to: generalized linear regression, random forest, support vector machine, gradient boosting regression, decision tree, generalized additive models, neural networks, deep learning, evolutionary programming, Bayesian inference, and reinforcement learning algorithms. Algorithms such as generalized linear regression, random forest, support vector machine, gradient boosting regression, decision tree, and generalized additive models may be preferred over neural networks, deep learning, and evolutionary programming algorithms.

A person skilled in the art will now appreciate that the teachings herein can improve the technological efficiency and computational and communication resource utilization across system 100. The teachings described herein improve technological efficiency by reducing redundant computations, reducing resource conflicts, and ensuring real-time synchronization across asynchronous interdependent systems. By integrating synchronization engine 120, method 500 enables dynamic resource allocation while avoiding race conditions and state mismatches that traditionally require manual intervention. This leads to a reduction in computational overhead, as engines 104 no longer need to operate in isolation or execute redundant state updates.

Communication resource utilization is optimized by ensuring that only necessary state changes propagate through network 108. Instead of broadcasting all updates indiscriminately, method 500 selectively synchronizes relevant engines 104 based on dependency tracking, thereby reducing network congestion and improving system response times. Additionally, by employing method 600, task-driven workflows are assigned only when prerequisite conditions are met, preventing unnecessary messaging traffic between patient terminals 116, administrator terminals 118, and backend engines 104.

Further, the modular and extensible architecture of system 100 allows integration across various domains beyond healthcare, including Smart Traffic Systems, Personalized Online Learning, and EV Charging Networks. Each implementation benefits from the same core computational efficiencies—avoiding stale state transitions, synchronizing interdependent tasks, and dynamically reallocating resources—leading to lower latency, improved automation, and more reliable system-wide performance across diverse asynchronous computing environments.

The present disclosure provides numerous advantages over conventional hospital discharge planning processes. It is to be understood that these advantages are not presented in terms of satisfying the current laws regarding statutory subject matter requirements of the claims—those teachings are provided elsewhere—and accordingly, this portion of the disclosure are irrelevant to whether the attached claims satisfy statutory subject matter requirements. Applicant reserves the right to delete these sections of the application should an examination process deem to wrongly use them as evidence against satisfaction of statutory subject matter requirements—they are irrelevant to examination and are included for the benefit of the public. These advantages are included in the spirit of full disclosure of the patent system for the benefit of the public, such that on expiry, the public is made fully aware of all possible reasons to implement the teachings herein. To that end: By integrating early discharge planning into a structured and interactive tool, the system reduces unexpected delays that often arise due to inefficient coordination between patients, caregivers, and healthcare providers. The issue of bed shortages, which is particularly acute across North America, is mitigated by ensuring that discharge planning begins early in a patient's hospitalization, thereby allowing for proactive identification of necessary post-discharge resources and reducing the likelihood of last-minute complications that could extend hospital stays.

The disclosed system further improves patient outcomes by enhancing adherence to follow-up care and reducing the risk of medical errors. By providing patients and caregivers with clear, structured discharge instructions that are accessible throughout the hospitalization period, the system helps mitigate confusion that often arises from conventional, last-minute discharge processes. As a result, the risk of readmission due to missed follow-ups or unmanaged post-discharge care is significantly reduced, thereby lowering overall healthcare costs and improving long-term patient health.

In addition to patient benefits, the system enhances hospital efficiency by optimizing bed turnover rates, an increasingly important factor in hospital resource management. By standardizing the discharge process and ensuring that all necessary steps are completed in a timely manner, the system allows hospitals to better allocate resources, improve patient flow, and maintain operational efficiency. Unlike traditional discharge planning, which is often inconsistent and fragmented, the disclosed tool provides a structured and transparent framework that ensures all relevant parties—patients, caregivers, and healthcare providers—are aligned throughout the discharge process.

Furthermore, the system enhances patient engagement by providing a centralized platform where discharge progress, outstanding requirements, and upcoming follow-up appointments are clearly communicated. This transparency empowers patients and caregivers, allowing them to take an active role in post-hospital care planning, thereby reducing anxiety and ensuring smoother transitions from hospital to home. By addressing inefficiencies in the existing discharge planning process, the present disclosure provides a comprehensive solution that improves healthcare system performance, enhances patient safety, and reduces avoidable hospital readmissions.

It should be recognized that features and aspects of the various examples provided above can be combined into further examples that also fall within the scope of the present disclosure. In addition, the figures are not to scale and may have size and shape exaggerated for illustrative purposes.

1. A computer-implemented method for synchronizing state transitions across a plurality of asynchronous engines in a computing environment, the method comprising:
receiving, via a synchronization engine, event data from at least one asynchronous engine, the event data comprising a timestamp and an engine identifier;
determining whether the received event data affects state dependencies in one or more other asynchronous engines;
querying the one or more affected asynchronous engines to retrieve their current state data;
generating a synchronization plan based on the retrieved state data, the synchronization plan specifying state transitions or resource reallocations required for consistency;
determining whether conflicts exist in the synchronization plan, and if so, resolving the conflicts automatically or escalating them for manual intervention;
executing the synchronization plan across the plurality of asynchronous engines;
validating whether the executed updates have been successfully applied; and
propagating finalized state updates to ensure system-wide consistency across the plurality of asynchronous engines.

2. The method of claim 1, wherein the asynchronous engines comprise at least one of a bed management engine, a physiotherapy scheduling engine, a pharmacy management engine, or a radiology engine.

3. The method of claim 1, wherein receiving event data further comprises assigning a priority level to each event based on event type and dependency impact.

4. The method of claim 1, wherein querying affected asynchronous engines further comprises retrieving associated historical state transitions to predict potential scheduling conflicts.

5. The method of claim 1, wherein generating a synchronization plan comprises dynamically reallocating resources across the asynchronous engines based on real-time system constraints.

6. The method of claim 1, wherein determining whether conflicts exist comprises detecting overlapping resource allocations, duplicate scheduling entries, or contradictory state transitions.

7. The method of claim 1, wherein validating updates comprises executing a test run of the synchronization plan before committing state changes.

8. The method of claim 1, wherein propagating finalized updates further comprises logging all state transitions in a centralized electronic health record system.

9. The method of claim 1, the synchronization engine ensures that discharge readiness is confirmed after completion of physiotherapy as logged by a physiotherapy scheduling engine.

10. The method of claim 1, wherein in a healthcare use case, the synchronization engine prevents a bed reassignment from occurring until all dependent post-operative processes, including medication reconciliation, have been validated.

11. A computer-implemented method for managing task-based workflows in an asynchronous computing environment, the method comprising:
receiving, via a workflow management engine, event data corresponding to a task assigned to an entity, the event data comprising a timestamp and an entity identifier;
delivering a task workflow to the entity via a computing terminal;
receiving input indicating workflow progress from the entity;
determining whether the received workflow progress input satisfies task completion criteria;
upon satisfying the task completion criteria, updating the event data to indicate task completion;
upon failure to satisfy the task completion criteria, updating the event data with an exception state; and
propagating the updated event data to dependent systems for further action.

12. The method of claim 11, wherein the computing terminal comprises a mobile device, a workstation, or a kiosk configured for task workflow presentation.

13. The method of claim 11, wherein the task workflow comprises a sequence of dependent steps, wherein each subsequent step is only presented upon successful completion of a prior step.

14. The method of claim 11, wherein determining whether workflow progress satisfies task completion criteria comprises verifying task completion against an external data source.

15. The method of claim 11, wherein upon detecting an exception state, triggering a notification to a supervisor or administrator for intervention.

16. The method of claim 11, wherein upon task completion, updating an associated scheduling system to reflect readiness for subsequent workflows.

17. The method of claim 11, wherein the task workflow is dynamically adjusted based on external conditions or real-time system changes.

18. The method of claim 11, further comprising issuing reminders if a task is not completed within a predefined timeframe.

19. The method of claim 11, wherein the task workflow comprises a rehabilitation program requiring data entry confirming completion of physiotherapy exercises before discharge processing can proceed.

20. The method of claim 11 preventing scheduling of patient discharge until a medication reconciliation task has been confirmed as complete within the pharmacy management engine.
